(19) United States
(12) Patent Application Publication
(10) Pub. No.: US 2008/0217261 A1
(43) Pub. Date: Sep. 11, 2008

(54) OFF-LINE TREATMENT OF HYDROCARBON FLUIDS WITH OZONE

(75) Inventors: Mukesh Kapila, The Woodlands, TX (US); Paul Newman, Bedford (CA); Ivan Batinic, Houston, TX (US); Rahul Dixit, Houston, TX (US); Paul Gover, Katy, TX (US); G. A. Addicks, Sugar Land, TX (US); Neale Browne, Houston, TX (US)

Correspondence Address: OSHA LIANG/MI, ONE HOUSTON CENTER, SUITE 2800, HOUSTON, TX, 77010, US

(73) Assignee: M-I LLC, Houston, TX (US)

(21) Appl. No.: 11/877,494

(22) Filed: Oct. 23, 2007

Related U.S. Application Data
(60) Provisional application No. 60/894,125, filed on Mar. 9, 2007.

(51) Int. Cl. C02F 1/78

(52) U.S. Cl. 210/760; 210/192; 210/205

(57) ABSTRACT

A system for treating recovered fluids off-line, the system including an ozone assembly and a reactor vessel operatively coupled to the ozone generator and having a reaction compartment and a settling compartment, wherein the reaction compartment is fluidly connected to a recovered hydrocarbons storage vessel and the settling compartment is fluidly connected to a treated oil tank is disclosed. Also disclosed is a method of treating recovered hydrocarbons off-line, the method including flowing recovered hydrocarbons from a storage vessel into a reactor vessel having a reaction compartment and a settling compartment, and injecting ozone from an ozone generator into the recovered hydrocarbons in the reaction compartment.

### CROSS-REFERENCE TO RELATED APPLICATIONS

This application claims priority under 35 U.S.C. § 119(e) to U.S. Provisional Application No. 60/894,125, filed on Mar. 9, 2007, which is herein incorporated by reference in its entirety.

### BACKGROUND OF MVENTION

1. Field of the Invention

Embodiments disclosed herein generally relate to a system for treating recovered fluids. More specifically, embodiments disclosed herein generally relate to an off-line system and method for treating recovered hydrocarbons and/or aqueous fluids with ozone.

2. Background Art

When drilling or completing wells in earth formations, various fluids typically are used in the well for a variety of reasons. For purposes of description of the background of the invention and of the invention itself, such fluids will be referred to as “well fluids.” Common uses for well fluids include: lubrication and cooling of drill bit cutting surfaces while drilling generally or drilling-in (i.e., drilling in a targeted petroleum bearing formation), transportation of “cuttings” (pieces of formation dislodged by the cutting action of the teeth on a drill bit) to the surface, controlling formation fluid pressure to prevent blowouts, maintaining well stability, suspending solids in the well, minimizing fluid loss into and stabilizing the formation through which the well is being drilled, fracturing the formation in the vicinity of the well, displacing the fluid within the well with another fluid, cleaning the well, testing the well, implacing a packer fluid, abandoning the well or preparing the well for abandonment, and otherwise treating the well or the formation.

As stated above, one use of well fluids is the removal of rock particles (“cuttings”) from the formation being drilled. A problem arises in disposing these cuttings, particularly when the drilling fluid is oil-based or hydrocarbon-based. That is, the oil from the drilling fluid (as well as any oil from the formation) becomes associated with or adsorbed to the surfaces of the cuttings. The cuttings are then an environmentally hazardous material, making disposal a problem.

A variety of methods have been proposed to remove adsorbed hydrocarbons from the cuttings. U.S. Pat. No. 5,968,370 discloses one such method which includes applying a treatment fluid to the contaminated cuttings. The treatment fluid includes water, a silicate, a nonionic surfactant, an anionic surfactant, a phosphate builder and a caustic compound. The treatment fluid is then contacted with, and preferably mixed thoroughly with, the contaminated cuttings for a time sufficient to remove the hydrocarbons from at least some of the solid particles. The treatment fluid causes the hydrocarbons to be desorbed and otherwise disassociated from the solid particles.

Furthermore, the hydrocarbons then form a separate homogenous layer from the treatment fluid and any aqueous component. The hydrocarbons are then separated from the treatment fluid and from the solid particles in a separation step, e.g., by skimming. The hydrocarbons are then recovered, and the treatment fluid is recycled by applying the treatment fluid to additional contaminated sludge. The solvent must be processed separately.

Some prior art systems use low-temperature thermal desorption as a means for removing hydrocarbons from extracted soils. Generally speaking, low-temperature thermal desorption (LTTD) is an ex-situ remedial technology that uses heat to physically separate hydrocarbons from excavated soils. Thermal desorbers are designed to heat soils to temperatures sufficient to cause hydrocarbons to volatilize and desorb (physically separate) from the soil. Typically, in prior art systems, some pre- and post-processing of the excavated soil is required when using LTTD. In particular, excavated soils are first screened to remove large cuttings (e.g., cuttings that are greater than 2 inches in diameter). These cuttings may be sized (i.e., crushed or shredded) and then introduced back into a feed material. After leaving the desorber, soils are cooled, re-moistened, and stabilized (as necessary) to prepare them for disposal/reuse.

U.S. Pat. No. 5,127,343 (the '343 patent) discloses one prior art apparatus for the low-temperature thermal desorption of hydrocarbons. FIG. 1 from the '343 patent reveals that the apparatus consists of three main parts: a soil treating vessel, a bank of heaters, and a vacuum and gas discharge system. The soil treating vessel is a rectangularly shaped receptacle. The bottom wall of the soil treating vessel has a plurality of vacuum chambers, and each vacuum chamber has an elongated vacuum tube positioned inside. The vacuum tube is surrounded by pea gravel, which traps dirt particles and prevents them from entering a vacuum pump attached to the vacuum tube.

The bank of heaters has a plurality of downwardly directed infrared heaters, which are closely spaced to thoroughly heat the entire surface of soil when the heaters are on. The apparatus functions by heating the soil both radiantly and convectionly, and a vacuum is then pulled through tubes at a point furthest away from the heaters. This vacuum both draws the convection heat (formed by the excitation of the molecules from the infrared radiation) throughout the soil and reduces the vapor pressure within the treatment chamber. Lowering the vapor pressure decreases the boiling point of the hydrocarbons, causing the hydrocarbons to volatize at much lower temperatures than normal. The vacuum then removes the vapors and exhausts them through an exhaust stack, which may include a condenser or a catalytic converter.

In light of the needs to maximize heat transfer to a contaminated substrate using temperatures below combustion temperatures, U.S. Pat. No. 6,399,851 discloses a thermal phase separation unit that heats a contaminated substrate to a temperature effective to volatize contaminants in the contaminated substrate but below combustion temperatures. As shown in FIGS. 3 and 5 of U.S. Pat. No. 6,399,851, the thermal phase separation unit includes a suspended air-tight extraction, or processing, chamber having two troughs arranged in a “kidney-shaped” configuration and equipped with rotating augers that move the substrate through the extraction chamber as the substrate is indirectly heated by a means for heating the extraction chamber.

In addition to the applications described above, those of ordinary skill in the art will appreciate that recovery of adsorbed hydrocarbons is an important application for a number of industries. For example, a hammermill process is often used to recover hydrocarbons from a solid. One recurring problem, however, is that the recovered hydrocarbons, whether they are received by either of the methods described above or whether by another method, can become degraded, either through the recovery process itself, or by the further use of the recovered hydrocarbons. This degradation may result in pungent odors, decreased performance, discoloration, and/or other factors which will be appreciated by those having ordinary skill in the art.

Accordingly, there exists a continuing need for systems and methods for treating recovered hydrocarbons to reduce odor and discoloration and improve performance.

### SUMMARY OF INVENTION

In one aspect, embodiments disclosed herein relate to a system for treating recovered fluids off-line, the system including an ozone assembly and a reactor vessel operatively coupled to the ozone generator and having a reaction compartment and a settling compartment, wherein the reaction compartment is fluidly connected to a recovered hydrocarbons storage vessel and the settling compartment is fluidly connected to a treated oil tank.

In another aspect, embodiments disclosed herein relate to a method of treating recovered fluids off-line, the method including flowing recovered hydrocarbons from a storage vessel into a reactor vessel having a reaction compartment and a settling compartment, and injecting ozone from an ozone generator into the recovered hydrocarbons in the reaction compartment until an optimal weight ozone per gram oil of recovered hydrocarbons is reached.

In yet another aspect, embodiments disclosed herein relate to a method of treating recovered fluids off-line, the method including flowing recovered hydrocarbons from a storage vessel into a reactor vessel having a reaction compartment and a settling compartment, and injecting ozone from an ozone generator into the recovered hydrocarbons in the reaction compartment for a pre-determined reaction time.

Other aspects and advantages of embodiments disclosed herein will be apparent from the following description and the appended claims.

### BRIEF DESCRIPTION OF DRAWINGS

FIG. 1 shows a process diagram of a system for treating recovered fluids with ozone in accordance with an embodiment disclosed herein.

### DETAILED DESCRIPTION

In one or more aspects, embodiments disclosed herein relate to systems and methods for treating recovered fluids, such as hydrocarbons and/or water. In particular, embodiments disclosed herein relate to systems and methods for treating hydrocarbons and/or water that have been recovered from solid materials with ozone.

When fluids are separated from drilling solids, by for example, a thermal phase separation (TPS) system, high temperatures used to drive the separation process cause thermal cracking and degradation of the oil and other drilling fluid components separated with the oil phase. The TPS system is configured to separate water and non-aqueous fluid from solid materials, e.g., drill cuttings. The separation process also creates chemical species that may give the oil and/or water an unpleasant odor and discolor the oil, which may negatively affect the marketability of the end product.

As noted above, a number of prior art methodologies for recovering adsorbed hydrocarbons from “cuttings” (i.e., rock removed from an earth formation) are currently used by hydrocarbon producers. While embodiments disclosed herein are not limited to this industry, the embodiments described below discuss the process in that context, for ease of explanation. In general, embodiments disclosed herein may be applied to any “cracked” hydrocarbon fluid or aqueous fluid. A “cracked” hydrocarbon fluid is one where at least some of the “higher” alkanes present in a fluid have been converted into “smaller” alkanes and alkenes.

A typical prior art process for hydrocarbon recovery, as described above, involves indirectly heating a material having absorbed materials thereon causing the hydrocarbons and/or aqueous fluids to volatilize. The volatized hydrocarbon and aqueous vapors are then extracted, cooled, condensed, and separated. As a result of the heating process, even at low temperatures, a portion of the recovered hydrocarbon and/or aqueous fluid may be degraded or contaminated. As used herein, the term degraded simply means that at least one property of the hydrocarbon fluid is worse than a “pure” sample. For example, a degraded fluid may be discolored, may have a depressed flashpoint, may have a pungent odor, or may have increased viscosity. “Recovered” hydrocarbons, as used herein, relate to hydrocarbons which have been volatized off of a solid substrate and condensed through any known method. As used herein, recovered hydrocarbons may also be referred to as a “TPS-separated oil” or an “oil.” Similarly, “recovered” aqueous fluids refer to aqueous fluids that similarly been volatized off of a solid substrate and condensed through any known method.

The present inventors have analyzed diesel oil that has undergone thermal cracking and have identified dimethyl disulfide, isobutyraldehyde, and toluene as possible contributors to certain degraded properties of the hydrocarbon fluid. These chemicals are typically not present in compositions of drilling fluids and may evolve from organoclays, drilling fluid additives, or contaminants from a drilled formation.

Ozone

In embodiments disclosed herein, a cracked hydrocarbon fluid and/or aqueous fluid is contacted with a stream of ozone. Ozone is known as an oxidizing agent, and previous studies have shown that ozone does not react with saturated compounds such as alkanes and saturated fatty acids. It is also known that ozone will react with unsaturated compounds such as alkenes, unsaturated fatty acids, unsaturated esters and unsaturated surfactants. The present inventors have discovered that by passing ozone through cracked hydrocarbons, improved hydrocarbon fluids may result. In particular, the present inventors have discovered that a reduction in odor and an improved coloration may occur. Reducing odor is of significant concern because of the increased regulation of pollution in hydrocarbon production. U.S. Patent Publication No. 2005/0247599, which is assigned to the present assignee and herein incorporated by reference in its entirety, discloses a system and method for treating a hydrocarbon fluid to reduce the pungent odors and discoloration of the hydrocarbon and increase performance. The method includes heating contaminated material to volatilize the contaminants and contacting the volatilized contaminants with an effective amount of ozone.

Embodiments of the present disclosure involve contacting a hydrocarbon fluid and/or aqueous fluid with an effective amount of ozone. An “effective amount,” as used herein, refers to an amount sufficient to improve a desired property (such as odor or color) in a hydrocarbon fluid. One of ordinary skill in the art would appreciate that the effective amount is a function of the concentration of the contaminants and the volume of the fluids to be treated. Further, the effective amount of ozone may also be a function of time.

Without being bound to any particular mechanism, the present inventors believe that the methods disclosed herein operate through a chemical reaction known as ozonolysis. The reaction mechanism for a typical ozonolysis reaction involving an alkene is shown below:

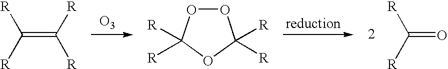

Thus, in the reaction, an ozone molecule (O₃) reacts with a carbon-carbon double bond to form an intermediate product known as ozonide. Hydrolysis of the ozonide results in the formation of carbonyl products (e.g., aldehydes and ketones). It is important to note that ozonide is an unstable, explosive compound and, therefore, care should be taken to avoid the accumulation of large deposits of ozonide.

Overtreatment of recovered fluids with ozone may result in oil having rancid or acidic properties due to an abundance of carboxylic acids, and may also result in the formation of a residue. Recovered fluids undertreated with ozone may still exhibit degraded properties as discussed above. Therefore, optimization of the ozone treatment process of recovered fluids is needed. Optimization of ozone dosage for the treatment of recovered fluids is discussed in more detail below.

The efficacy of ozone as an agent to improve at least one property of a hydrocarbon fluid was investigated. In this embodiment, recovered hydrocarbons were used. One suitable source for the recovered hydrocarbons is described in U.S. patent application Ser. No. 10/412,720 (Publication No. 2004/0204308), which is assigned to the assignee of the present invention. That application is incorporated by reference in its entirety.

Another suitable source of recovered hydrocarbons is described in U.S. Pat. No. 6,658,757, which is assigned to the assignee of the present disclosure. That patent is incorporated by reference in its entirety, These two methods of obtaining recovered hydrocarbons are merely examples, and the scope of the present invention is not intended to be limited by the source of the fluid to be treated.

System and Method for Treating Recovered Fluids

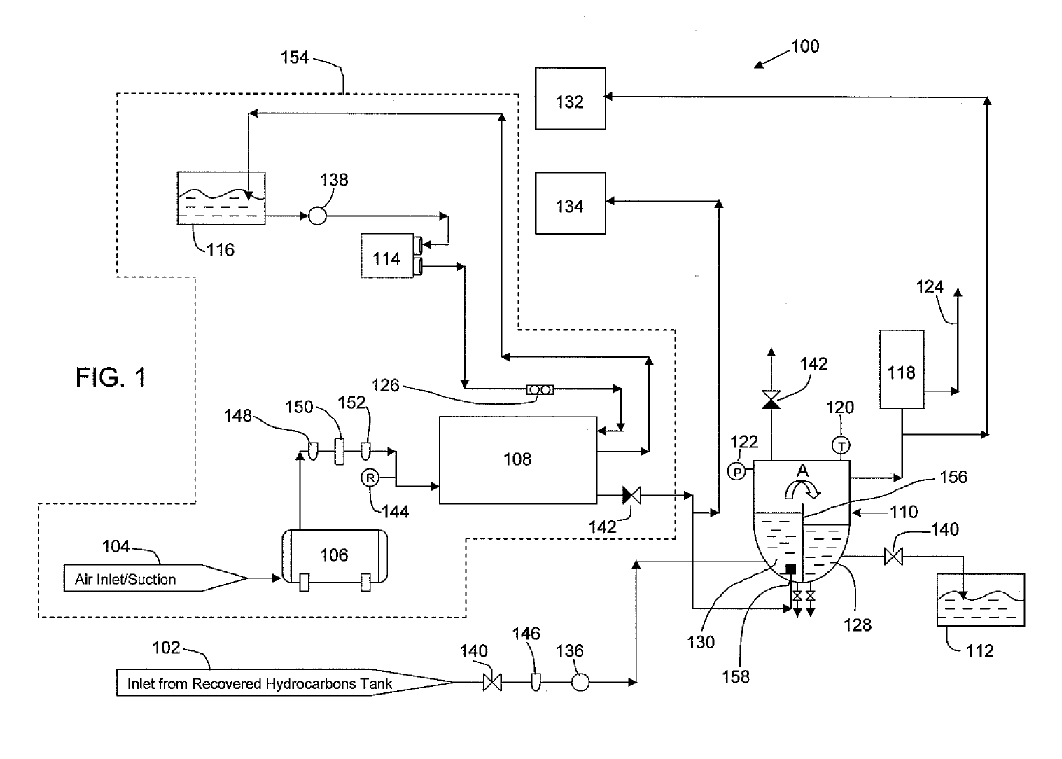

FIG. 1 shows a system 100 for treating recovered fluids with ozone in accordance with an embodiment disclosed herein. In the embodiment shown, the system 100 provides off-line treatment of recovered hydrocarbons. As used herein, “off-line” refers to a system or process that is performed independently or separately from a main operation. In other words, systems for treating recovered hydrocarbons in accordance with embodiments disclosed herein are separate from and operate separately from oil production and total phase separation systems, including, for example, thermal phase separation units. Thus, system 100 may be operated at ambient pressures and may be operated with small volumes.

In one embodiment, system 100 includes a recovered hydrocarbons inlet 102 and a pump 136 configured to pump recovered hydrocarbons from a storage tank, oil drum, or any other storage vessel that stores recovered hydrocarbons. One of ordinary skill in the art will appreciate that the recovered hydrocarbons may result from any hydrocarbon recovery process described above or known in the art. In one embodiment, an oil filter 146 may be disposed before pump 136 to retain any residual contaminants in recovered hydrocarbons. Additionally a valve 140 may be operatively coupled to the inlet 102 to control the flow rate of recovered hydrocarbons.

The recovered hydrocarbons are transferred via pump 136 to reactor vessel 110. The size of reactor vessel 110 may be selected based on the desired amount of recovered hydrocarbons to be treated. For example, in one embodiment, reactor vessel 110 may have a volume of 30 L. In one embodiment, reactor vessel 110 is divided into two compartments, a reaction compartment 130 and a settling compartment 128. In the embodiment shown, the reaction compartment 130 and the settling compartment 128 may be separated by a weir 156 that allows for the transfer of fluid at a pre-determined level from the reaction compartment 130 to the settling compartment 128. One of ordinary skill in the art will appreciate that reactor vessel 100 may include more than two compartments and two weirs without departing from the scope of embodiments disclosed herein. As shown, the recovered hydrocarbons are pumped into reaction compartment 130.

In the embodiment shown, an ozone assembly 154, configured to generate ozone, is fluidly connected to reactor vessel 110. In particular, ozone assembly 154 is configured to generate and transfer ozone into recovered hydrocarbons inside reaction compartment 130. As described above, an ozone molecule (O₃) reacts with a carbon-carbon double bond to form an intermediate product known as ozonide. Once the pre-determined level of recovered hydrocarbons in reaction compartment 130 is reached, the ozone treated recovered hydrocarbons spill (indicated at A) into settling compartment 128.

The pre-determined level of recovered hydrocarbons is selected based on the desired time of ozone reaction. In other words, the height of weir 156 is determined based on the desired reaction time of ozone (i.e., the length of time that the hydrocarbon fluids are subjected to ozone) that results in optimal weight ozone per gram oil. In one embodiment, the desired weight ozone per gram fluid treated is between 1,000 and 14,000 ppm O₃ per gram of fluid treated. In another embodiment, the weight ozone per gram fluid is between 4,000 and 10,000 ppm O₃ per gram of oil fluid. In yet another embodiment, the weight ozone per gram fluid is between 4,000 and 8,000 ppm O₃ per gram of oil fluid.

While the embodiment shown discloses treating recovered hydrocarbons, the treatment system may also be used to treat degraded aqueous fluids. Thus, instead of an inlet 102 for recovered hydrocarbons, such alternative system 100 includes a recovered aqueous fluids inlet 102 and a pump 136 configured to pump recovered aqueous fluids from a storage tank, drum, or any other storage vessel that stores recovered aqueous fluids that may be separated, for example, from cuttings (and hydrocarbons) in a thermal recovery process. One of ordinary skill in the art will appreciate that the recovered aqueous fluids may result from any hydrocarbon recovery process described above or known in the art. In embodiments where an aqueous fluid is treated, such desired weight ozone per gram fluid is between 1,000 and 4,000 ppm O₃ per gram of aqueous liquid, between 1,500 and 3,000 ppm O₃ per gram of aqueous liquid in other embodiments, and about 2,000 ppm O₃ per gram of aqueous liquid in yet other embodiments. One of ordinary skill in the art will appreciate that the reaction time required to result in a desired weight ozone per gram fluid treated is dependent on various factors, including for example flow rate of recovered hydrocarbons, flow rate of ozone, and pressure of injected ozone.

Further, one of ordinary skill in the art would appreciate that an effective amount of ozone may depend on the particular sample of recovered hydrocarbons to be treated. Further, while the above mentioned amounts of ozone may be sufficient to ozonate the recovered hydrocarbons (or water), it may be desirable to reduce the amount of ozone introduced to the flow lines to reduce and/or prevent over treatment of the recovered hydrocarbons, which may, for example, result in the formation of a residue. In particular, the inventors of the present disclosure have also recognized that the formation of a residue substance in equipment, etc., may be used to monitor the amount and/or flow rate of ozone introduced in the systems of the present disclosure. That is, upon detection of the residue, such as by visual detection or other automated means known in the art, the concentration of the ozone may be reduced and/or the flow rate of the ozone may be increased to reduce the formation of residue and thus avoid overtreatment.

For example, in one embodiment, as discussed in more detail in the examples below, for a sample of 500 mL of recovered hydrocarbons sparged with ozone from an ozone generator having a gas feed of 1.625 L/min, 1.3 psig inlet pressure, and 100% ozone concentration at ambient pressure, the desired reaction time is between 20 minutes and 60 minutes. In another embodiment, the reaction time is between 40 and 50 minutes. In yet another embodiment, the reaction time is approximately 45 minutes. As shown in the example below, these reaction time ranges result in a weight ozone per gram oil range of 1,000 to 14,000 ppm O₃ per gram of fluid treated.

One or more temperature gauges 120 may be operatively connected to reactor vessel 110 to determine the temperature inside the vessel 110. Additionally, one or more pressure gauges 122 may be operatively coupled to reactor vessel 110 to determine the pressure inside vessel 110. In one embodiment, the pressure inside reactor vessel 110 is 14.69 psi or 1 atm. Thus, in one embodiment, the reaction time may be adjusted based on the temperature and pressure inside reactor vessel 110.

Ozone assembly 154 includes an ozone generator 108 and an air compressor 106 configured to take air through an inlet 104 and transfer compressed air to ozone generator 108. Ozone generator 108 is configured to receive the compressed air from air compressor 106 and water from a water tank 116. Any ozone generator known in the art may be used, such that the ozone generator supplies a pre-determined flow and concentration of ozone to reactor vessel 110. Commercial ozone generators are available from a variety of vendors, for example, Model LG-7 ozone generator by Ozone Engineering, Inc. (El Sobrante, Calif.). A plurality of filters, for example coalescent filter 148 and particle filter 152, and an air dryer 150 may be operatively coupled between the air compressor 106 and ozone generator 108 to remove or reduce any contaminants or moisture in the compressed air. In one embodiment, a pressure regulator 144 may be operatively connected to an air flow line from air compressor 106 to regulate the pressure of the compressed air entering ozone generator 108.

In one embodiment, ozone assembly 154 may further include a chiller 114 configured to receive and cool water pumped 138 from water tank 116. Cooled water may then be transferred to ozone generator 108. The water transferred to ozone generator 108 may be circulated back to water tank 116 and recycled through chiller 114 and ozone generator 108, thereby forming a cooling loop. In some embodiments, a flow meter 126 may be operatively coupled between chiller 114 and ozone generator 108 to measure the flow rate of water to ozone generator 108.

Ozone generator 108 generates a flow of ozone that enters the reaction compartment 130 of reactor vessel 110. A one-way valve 142 may be operatively coupled to ozone generator 108 to control the flow rate of ozone to reaction compartment 130. The ozone generator 108 is configured to provide a selected amount of ozone (selected in, for example, grams/hour) to the recovered hydrocarbons within reaction compartment 130, such that the resultant treated oil contains a pre-determined weight ozone per gram oil for a specified reaction time. In one embodiment, for example, ozone generator 108 may provide up to 120 g/hr ozone to reaction compartment 130.

In some embodiments, an ozone monitor 134 may be operatively coupled between ozone generator 108 and reactor vessel 110 to monitor the amount of ozone transferred to the reaction compartment 130. One of ordinary skill in the art will appreciate that any ozone monitor may be used, for example, a Model 454-M ozone process monitor, provided by API, Inc. (San Diego, Calif.).

In the embodiment shown, once a pre-determined level of ozone treated recovered hydrocarbons is reached and exceeded, ozone treated recovered hydrocarbons spill over (indicated at A) weir 156 into settling compartment 128. In some embodiments, a viscous residue may settle out of the ozone treated recovered hydrocarbons in settling compartment 128 of reactor vessel 110. Ozone treated recovered hydrocarbons are then transferred through a conduit to a treated oil storage tank 112. One of ordinary skill in the art will appreciate that any vessel, tank, or barrel may be used to store the treated oil. A valve 140 may be used to control the rate of flow between settling compartment 128 and the treated oil storage tank 112. Treated recovered hydrocarbons may then be sold to clients, recirculated through the system 100, or used to build oil-based drilling fluids.

Reactor vessel 110 may further include a one way valve 142 configured to vent gases out of the vessel 110. Additionally, an ozone destruction unit 118 may be operatively coupled to reactor vessel 110 to remove excess ozone from the vessel 110, safely convert the ozone back into oxygen, and then vent 124 the safe gases to the atmosphere. In one embodiment, ozone destruction unit 118 may include a cylinder packed with MgO pellets. MgO acts as a catalyst to convert ozone back into oxygen, and is not consumed by contact with ozone or air. However, one of ordinary skill in the art would appreciate that other types of ozone destruction units may be used, such as a high temperature oxidizer, which may be effective at destroying ozone. In some embodiments, an ozone monitor 132 may be operatively coupled between reactor vessel 110 and ozone destruction unit 118 to monitor the amount of ozone transferred. One of ordinary skill in the art will appreciate that any ozone monitor may be used, for example, a Model 454-M ozone process monitor, provided by API, Inc. (San Diego, Calif.).

### EXAMPLES

Ozone has been shown, for example, in U.S. Publication No. 2005/0247599, to be an effective eliminator of cracked oil odors. In previous studies, low dosages such as 3 g/day, 8 g/day, and 12 g/day of ozone were applied over a period of several days. In contrast, in certain embodiments disclosed below, up to 7 g/hr of ozone was applied to recovered hydrocarbons for a period up to 4 hours.

### Example 1

In order to establish appropriate flow rates of oxygen into an ozone generator, a 500 ml sample of recovered hydrocarbon was placed in a cylinder. Ozone was bubbled through the cylinder at a rate of 7 g/hr. Commercial ozone generators are available from a variety of vendors. For this particular embodiment, a Model LG-7 ozone generator sold by Ozone Engineering, Inc. (El Sobrante, Calif.), capable of producing up to 7 g/hr ozone at 0-100% concentration at 0-10 L/min at 0-10 psig, was used to treat recovered hydrocarbons.

The top of the cylinder remained open to the air, in order to avoid a build up of ozonide. However, a vacuum blower could also be used to continuously purge the ozonide. In this embodiment, the untreated sample of recovered hydrocarbons was deep brown in color, almost black, and opaque. Pungent sulfur-like and charred odors were present. The specific gravity (SG) of the recovered hydrocarbons was measured to be 0.84 g/ml. After approximately 45 minutes of ozone treatment at a variable concentrations and flow rates, the recovered hydrocarbon became noticeably lighter in color, a tea-colored shade of brown. A small amount of highly viscous residue was collected on the walls of the cylinder near the surface of the recovered hydrocarbons. The odor was reduced, but still contained traces of a burnt or charred odor. It was discovered that by contacting the ozone with the recovered hydrocarbons for 4 hours at variable concentrations and flow rates, the recovered hydrocarbons was substantially transparent, faint yellow, and devoid of sulfur odors. However, a rancid, acidic odor was detected. Additionally, a heavy layer, approximately 0.5 inches in depth, of viscous residue, orange-brown in color, had collected on the walls and bottom of the cylinder.

From this experimental set up, it was determined that a flow rate of 1.625 L/min of oxygen feed to the ozone generator with an oxygen inlet pressure of 1.3 psig, and an ozone monitor pressure of 1.2 psig was desired for the system as described in this example.

### Example 2

Using the experimental equipment set up and determined flow rates and pressures of Example 1, a series of tests was performed to determine an optimal reaction time of ozone and recovered hydrocarbons to reduce odors without overtreatment and with minimal accumulation of heavy residue. In this example, gas flow rate, inlet pressure, and ozone concentration were held constant, and the time period of reaction were varied. The reaction times tested were 30 minutes, 60 minutes, and 90 minutes. For each test, a new untreated 500 ml sample of recovered hydrocarbons was used.

The results of the ozone treated samples are summarized in Table 1 below. Each ozone treated sample resulted in some residue accumulation that was easily removed from the test cylinder and weighed.

TABLE 1
Ozone Treated Recovered Hydrocarbons Results

| | | | | | Total ppm | |
|---|---|---|---|---|---|---|
| Reaction | | | Wt. | Total O₃ | O₃ per g | SG oil, |
| time | Appearance | Odor | Residue, g | added, g | sample | g/ml |
| 30 minutes | Medium brown | Charred, but low | 1.27 | 2.71 | 6460 | 0.8095 |
| 60 minutes | Orange brown | Paraffinic | 1.39 | 5.82 | 13866 | 0.8315 |
| 90 minutes | Orange yellow | Acidic, pungent | 3.10 | 9.12 | 21716 | 0.8355 |

The four samples, including a control, untreated oil sample, were analyzed on a gas chromatograph/mass spectrometer (CG/MS) to determine concentration of paraffins, iso-paraffins, aromatics, napthenics, olefins, aldehydes, ketones, and acids (the latter three collectively called “other compounds”), collectively referred to as “PIONA.” The concentration of benzene, toluene, ethylbenzene, and xylene, collectively referred to as “BTEX” were also determined. The color and flash points of the recovered hydrocarbons were also determined after each test, in accordance with ASTM D-1500 and D-93, respectively. In addition, the concentration of hydrocarbons in each sample was determined. The results are summarized in Table 2 below.

TABLE 2
CG/MS Data for Untreated and Ozone Treated Recovered Hydrocarbons

| Property | Untreated oil | 30 min. | 60 min. | 90 min. |
|---|---|---|---|---|
| PIONA tests: | | | | |
| Total paraffins, wt % | 23.93 | 23.22 | 26.05 | 23.38 |
| Total isoparaffins, wt % | 36.24 | 36.53 | 37.45 | 34.55 |
| Total aromatics, wt % | 11.24 | 11.21 | 11.24 | 8.69 |
| Total naphthenics, wt % | 18.43 | 19.08 | 17.19 | 18.33 |
| Total olefins, wt % | 6.25 | 5.52 | 3.66 | 5.88 |
| Other*, wt % | 3.91 | 4.44 | 4.41 | 9.17 |
| BTEX tests: | | | | |
| Benzene, ppm | 0.001 | 0.001 | 0.001 | <0.001 |
| Toluene, ppm | 0.006 | 0.005 | 0.006 | 0.005 |
| Ethylbenzene, ppm | 0.005 | 0.005 | 0.005 | 0.005 |
| Xylene, ppm | 0.018 | 0.034 | 0.041 | 0.037 |
| Total BTEX | 0.030 | 0.045 | 0.053 | 0.047 |
| Color, ASTM D-1500 | 7.5 | 4.5 | 3.5 | 2.0 |
| Hydrocarbons by gc/ms | | | | |
| C4 to C8, % conc. | 0.17 | 0.14 | 0.23 | 0.28 |
| C9 to C13, % conc. | 21.91 | 24.08 | 23.35 | 23.16 |
| C14 to C18, % conc. | 47.65 | 46.94 | 46.48 | 46.18 |
| C19 to C23, % conc. | 23.98 | 22.84 | 23.47 | 23.57 |
| C24 to C28, % conc. | 5.17 | 4.97 | 5.30 | 5.46 |
| C29 to C33, % conc. | 0.85 | 0.79 | 0.90 | 1.01 |
| C34 to C44, % conc. | 0.28 | 0.23 | 0.27 | 0.33 |
| C45 to C49, % conc. | not detected | not | not | not detected |
| | | detected | detected | |
| Flash Point, ASTM D-93 | 190 F. | 190 F. | 193 F. | 192 F. |

Depletion of olefins and the accumulation of species in the “others” category is consistent with the reaction of ozone at the reactive double-bond site on an olefin molecule, and with the increase in odors and with an acidic character over ozone treatment time.

### Example 3

The recovered hydrocarbons (TPS-separated oil) treated for 30 and 60 minutes were used as base oils to build two conventional oil-based mud samples of 350 mL each to determine the behavior of the treated recovered hydrocarbons during their end use, e.g., as a base oil in building drilling fluids. The mud included a mud weight of 10 lb/gallon, an oil-water ratio (OWR) of 80/20, and a brine phase of 25% weight CaCl₂. In addition, a sample was built using untreated recovered hydrocarbons (untreated TPS-separated oil) and another sample using No. 2 Diesel. The rheology of the samples was determined using a FANN-35 Viscometer, and the results are summarized in Table 3 below.

TABLE 3
Rheology of Mud Samples

| | Mud built with base oil: | | | |
|---|---|---|---|---|
| | Diesel | 30 min | 60 min | TPS Oil |
| Retort Analysis @ | | | | |
| 1200 F. | | | | |
| MIs Water | 5.30 | 5.40 | 5.30 | 5.50 |
| MIs Oil | 12.70 | 12.70 | 12.70 | 12.80 |
| MIs Solids | 2.00 | 1.90 | 2.00 | 1.70 |
| | vol % | vol % | vol % | vol % |
| % Water | 26.50 | 27.00 | 26.50 | 27.50 |
| % Oil | 63.50 | 63.50 | 63.50 | 64.00 |
| % Solids | 10.00 | 9.50 | 10.00 | 8.50 |
| O/W Ratio | 70.6/29.4 | 70.2/29.8 | 70.6/29.4 | 69.9/30.1 |
| SG at 70 F. | 1.23 | 1.18 | 1.20 | 1.22 |
| Density, lb/gal | 10.21 | 9.83 | 9.98 | 10.14 |
| Rheology @ 150 F. | | | | |
| 600 rpm | 103 | 65 | 54 | 79 |
| 300 rpm | 66 | 39 | 32 | 51 |
| 200 rpm | 49 | 29 | 23 | 41 |
| 100 rpm | 34 | 18 | 15 | 30 |
| 6 rpm | 18 | 6 | 5 | 15 |
| 3 rpm | 16 | 5 | 5 | 14 |
| PV, cP | 37 | 26 | 22 | 28 |
| YP, lb/100 ft2 | 29 | 13 | 10 | 23 |
| 10 s gel | 18 | 8 | 7 | 18 |
| 10 min gel | 23 | 14 | 11 | 26 |
| ES @ 120 F. (volts) | 470 | 113 | 84 | 245 |
| POM, ml | 0.55 | 0.20 | 0.20 | 0.40 |
| Chlorides, mg/L | 60500 | 56500 | 58000 | 57500 |
| % HG Solids | 8.45 | 7.38 | 7.22 | 9.94 |
| % LG Solids | −0.87 | −0.10 | 0.48 | −3.71 |
| Corrected % HGS | 7.58 | 7.28 | 7.22 | 6.23 |
| Corrected % LGS | 0.00 | 0.00 | 0.48 | 0.00 |

As shown in Table 3, the Theological properties of muds built with the TPS-separated oil, treated and untreated, are lower than those of the mud built with diesel. Reduction in plastic viscosity may be attributed to the viscosity of the base oil. The samples treated with ozone showed a reduction in yield point and gel strength, as compared to the diesel sample. This reduction in the yield point may be attributed to the formation of acidic material, e.g., carboxylic acids, during ozone treatment. Acidic material may cause dispersion and deflocculation of clay particles by neutralizing the cations on the surface of the clays so that the particles repel one another. This in turn reduces yield point and gel strengths. The presence of acidic material is further indicated by a lower POM value in the muds built with ozone treated oil. Low POM are often followed by weakening emulsions, and the electrical stability values of the two muds built with ozone treated oil are both lower, indicating a loss of stability in the brine-in-oil emulsion. Thus, higher dosages of alkaline material, emulsifiers, and viscosifiers may be used in the formulation to counteract the effects of residual acids.

### Example 4

Processed oil from a hammermill reactor, such as that described in 6,658,757, or a thermal reactor, such as that described in U.S. Patent Publication No. 2004/0204308, was pumped into a 30 liter reaction chamber, where it was contacted with ozone introduced by a diffuser. The oil and dispersed gas flow upward until reaching a weir, over which oil spills and cascades into a separate chamber, losing the dispersed gas in the process. The oil flow by gravity into a collection chamber. The treatments and results are shown below in Table 4.

TABLE 4

| Sample | Treatment | Results |
|---|---|---|
| 1 | Condensed Oil from a hammermill | The charred odor from the condensed oil was removed by it |
| | process was processed through the | was replaced by a sharp rancid acidic odor, indicating |
| | reaction chamber at a rate of 7 L/hr | overtreatment. The oil was lightened to a lighter shade of |
| | with ozone injected in at 80% or 96 g/hr | yellow. During the first 60 minutes of the treatment, a |
| | of ozone in air (16134 ppm | temperature rise from 78° F. to 110° F. was noted, with |
| | ozone in oil by weight). A total of | stabilization at 110° F. Concentration of ozone in the offgas |
| | 21.5 L were processed. | ranged from 1.4 to 7 g/m³. A small amount of residue, about |
| | | 20 mL in volume, was collected from the reaction chamber at |
| | | the end of the process. |
| 2 | Oil from an oil/water separation from | Color was slightly reduced from a pale yellow shade, odor was |
| | a hammermill process was | removed, and no acidic odor was noted, suggesting little or no |
| | processed at 10 L/hr with ozone | overtreatment during the test. A temperature rise of 78° F. to |
| | injected at 50% of 70 g/hr of ozone | 100° F. over the first 50 minutes with stabilization at 100° F. was |
| | (8235 ppm ozone in oil by weight). | noted. Offgas ozone concentration ranged from 0.1 to 0.6 g/m³. |
| | A total of 15 L were processed. | About 20 mL in volume, was collected from the reaction |
| | | chamber at the end of the process. |
| 3 | Condensed Oil from a hammermill | Odor was removed, and no acidic odor was noted, suggesting |
| | process was processed through the | little or no overtreatment during the test. Color was slightly |
| | reaction chamber at a rate of 14 L/hr | reduced from the original yellow shade. A temperature rise of |
| | with ozone injected in at 60% or | 78° F. to 90° F. over the first 62 minutes with stabilization at 90° F. |
| | 84.6 g/hr of ozone in air (7194 ppm | was noted. Offgas ozone concentration ranged from 0.2 to 0.9 g/m³. |
| | ozone in oil by weight). A total of 17 L | About 20 mL in volume, was collected from the reaction |
| | were processed. | chamber at the end of the process. |
| 4 | Recovered Oil from a thermal | The oil became lighter in color, and a minor odor remained. A |
| | reactor process was processed | temperature rise of 78° F. to 98° F. over the first 50 minutes with |
| | through the reaction chamber at a | stabilization at 98° F. was noted. Offgas ozone concentration |
| | rate of 10 L/hr with ozone injected in | was consistently around 0.6 g/m³. About 20 mL in volume, was |
| | at 70% or 90 g/hr of ozone in air | collected from the reaction chamber at the end of the process |
| | (10588 ppm ozone in oil by weight). | |
| | A total of 15 L were processed. | |
| 5 | A control experiment sparged air | There was no reduction of odor or color without ozone, and no |
| | without ozone for 3 days on | residue was formed. No changes in temperatures and |
| | condensed oil from Sample 3. | pressures were observed. |

### Example 5

### Field Trial

Oily solids were treated in a hammermill, in which liquids are evaporated from the mineral solids and transferred out of the process chamber. After removal of entrained solids by a cyclone, the vaporized liquids are recondensed and directed to an oiuwater separator (OWS) which allows the aqueous and hydrocarbon fractions to partition into separate layers. The water and oil fractions exit the OWS as separate streams. Samples from streams exiting the OWS were treated with ozone in a reactor chamber such as the one described in Example 4. The first test lasted 24 hours, and involved treatment of the oil stream that exited the OWS. After 24 hours, the oil flow rate into the reaction chamber was increased for the second test. The third test involved the treatment of the water recovered from the OWS, which possessed a significant odor similar to that of recovered oil. The results of the tests are shown below in Table 5.

TABLE 5

| | Duration | Total L | Avg | Max | Avg | Max | | Avg ppm | Avg | |
|---|---|---|---|---|---|---|---|---|---|---|
| Test | hrs | Processed | g/hr O₃ | g/hr O₃ | wt % O₃ | wt % O₃ | L/hr oil | O₃ in oil | vessel ° F. | Max ° F. |
| 1 | 24 | 240 | 56.4 | 75 | 2.43 | 3.10 | 10 | 6635 | 100.5 | 111 |
| 2 | 20 | 280 | 51 | 56 | 2.10 | 2.32 | 14 | 4286 | 87.4 | 100 |
| 3 | 6 | 84 | 40.6 | 46 | 1.63 | 1.90 | 14 | 2900 | 89.5 | 91 |

During the first test, accumulation of a viscous residue was observed within the oxidation reaction chamber and on the surface of objections within the chamber, including the ozone sparge inlet. However, during the second test, when the increased oil flow rate resulted in lower vessel temperatures, the residue accumulation was significantly lower.

Advantageously, embodiments disclosed herein may provide a system and method for treating recovered hydrocarbons with ozone. In particular, embodiments disclosed herein may provide a system and method for reducing odors in recovered hydrocarbons caused by high temperature and thermal cracking. Additionally, embodiments disclosed herein may provide an off-line treatment system and method for treating relatively small volumes of recovered hydrocarbons at ambient pressure.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed:

1. A system for treating recovered fluids off-line, the system comprising:
an ozone assembly; and
a reactor vessel operatively coupled to the ozone generator and having a reaction compartment and a settling compartment;
wherein the reaction compartment is fluidly connected to a recovered fluid storage vessel and the settling compartment is fluidly connected to a treated fluid tank.

2. The system of claim 1, wherein the ozone assembly comprises:
an ozone generator fluidly coupled to the reaction compartment and configured to generate ozone; and
an air compressor fluidly coupled to the ozone generator.

3. The system of claim 2, further comprising a chiller operatively coupled to the ozone generator and a water tank.

4. The system of claim 1, further comprising an ozone destruction unit operatively coupled to the reactor vessel.

5. The system of claim 1, wherein the reactor vessel comprises a weir disposed between the reaction compartment and the settling compartment.

6. The system of claim 5, wherein a height of the weir is selected to provide a pre-determined reaction time.

7. The system of claim 1, further comprising at least one ozone monitor operatively coupled to at least one selected from the group consisting of the ozone generator and the reactor vessel.

8. A method of treating recovered fluids off-line, the method comprising:
flowing recovered hydrocarbons from a storage vessel into a reactor vessel having a reaction compartment and a settling compartment; and
injecting ozone from an ozone generator into the recovered hydrocarbons in the reaction compartment until an optimal weight ozone per gram oil of recovered hydrocarbons is reached.

9. The method of claim 8, wherein the optimal weight ozone per gram oil is between 4,000 and 14,000 ppm ozone per gram oil.

10. The method of claim 8, wherein the optimal weight ozone per gram oil is between 4,000 and 8,000 ppm ozone per gram oil.

11. The method of claim 8, further comprising:
spilling ozone treated recovered hydrocarbons over a weir into the settling compartment;
allowing residue in the ozone treated recovered hydrocarbons to settle; and
flowing ozone treated recovered hydrocarbons to a treated oil tank.

12. The method of claim 8, further comprising circulating water through a chiller and the ozone generator.

13. The method of claim 8, further comprising monitoring the flow rate of ozone from the ozone generator to reaction compartment.

14. The method of claim 8, further comprising:
removing excess ozone from the reactor vessel to a ozone destruction unit;
converting the excess ozone to oxygen; and
venting the oxygen.

15. A method of treating recovered fluids off-line, the method comprising:
flowing recovered hydrocarbons from a storage vessel into a reactor vessel having a reaction compartment and a settling compartment; and
injecting ozone from an ozone generator into the recovered hydrocarbons in the reaction compartment for a pre-determined reaction time.

16. The method of claim 15, wherein the pre-determined reaction time is a function of at least one of ozone flowrate, ozone pressure, and ozone concentration.

17. The method of claim 15, wherein the pre-determined reaction time is determined based on a pre-selected weight ozone per gram oil.

18. The method of claim 17, wherein the pre-selected weight ozone per gram oil is between 4,000 and 14,000 ppm ozone per gram oil.

19. The method of claim 15, further comprising:
spilling ozone treated recovered hydrocarbons over a weir into the settling compartment;
allowing residue in the ozone treated recovered hydrocarbons to settle; and
flowing ozone treated recovered hydrocarbons to a treated oil tank.

20. A method of treating recovered fluids off-line, the method comprising:
flowing recovered fluid from a storage vessel into a reactor vessel having a reaction compartment and a settling compartment; and
injecting ozone from an ozone generator into the recovered fluid in the reaction compartment until an optimal weight ozone per gram of recovered fluid is reached.

21. The method of claim 21, wherein the recovered fluid comprises a recovered aqueous fluid.

22. The method of claim 20, wherein the optimal weight ozone per gram fluid is between 1,000 and 4,000 ppm ozone per gram aqueous fluid.

23. The method of claim 21, further comprising:
spilling ozone treated recovered aqueous fluid over a weir into the settling compartment; and
flowing ozone treated recovered aqueous fluid to a treated aqueous fluid tank.
